(19) United States
(12) Patent Application Publication
(10) Pub. No.: US 2022/0207433 A1
(43) Pub. Date: Jun. 30, 2022

(54) Method and System For Classification Prediction and Model Deployment

(71) Applicant: Cognizant Technology Solutions U.S. Corporation, College Station, TX (US)

(72) Inventors: Subir Das, Pleasanton, CA (US); Michael Oczkowski, Boulder, CO (US); Kavitha Lokesh, Belle Mead, NJ (US); Sankar Pariserumperumal, College Station, TX (US)

(73) Assignee: Cognizant Technology Solutions U.S. Corporation, College Station, TX (US)

(21) Appl. No.: 17/532,019

(22) Filed: Nov. 22, 2021

Related U.S. Application Data
(60) Provisional application No. 63/116,353, filed on Nov. 20, 2020.

(51) Int. Cl. G06N 20/20; G06N 20/10

(52) U.S. Cl. CPC G06N 20/20; G06N 20/10

(57) ABSTRACT

An artificial intelligence (AI) prediction engine is used to correctly classify an entity based on a predetermined classification taxonomy, e.g., NAICS. The engine and process for using takes as inputs an entity's social presence (e.g., name, web address, etc.) and address. The AI prediction engine employs various machine learning models to make a classification prediction.

### CROSS-REFERENCE TO RELATED APPLICATION

The present application claims the benefit of priority to U.S. Provisional Patent Application No. 63/116,353, “BUSINESS CLASSIFICATION & MODEL DEPLOYMENT FRAMEWORK” which was filed on Nov. 20, 2020 and which is incorporated herein by reference in its entirety.

### BACKGROUND

### Field of the Embodiments

The embodiments are in the field of model core development and specifically, establishment of a framework for model development which provides standardization or a template for model deployment/production so that an enterprise can standardize deployment, debugging, testing of multiple models, model maintenance, model degradation monitoring, etc.

### Description of Related Art

Numerous industries rely on elaborate classification taxonomies to filter data for various purposes, including, but not limited to: payments, loan approval, insurance, benefits, import/export control. Inaccurate coding results in time delays and monetary loss. Examples of classification taxonomies that are critical to various industries include: North American Industry Classification System (NAICS); Current Procedural Codes (CPT) maintained by the American Medical Association; and Harmonized System (HS) Codes administered by the World Customs Organization for exports.

By way of specific example, classification of business as per U.S. industry code, e.g., NAICS, is necessary for risk identification and policy binding. Large financial institutions, e.g., insurance companies, lending organizations, etc., receive new submissions for small commercial businesses every day (e.g., on the order of 1000+ daily) and less than 10% are converted into binding policies. Several friction points exist between business owner, agent and underwriter, leading to high turnaround time and loss of business. Inaccurate classification of businesses also leads to deals being underpriced or overpriced. Accordingly, there is a need in the art for improved and on-demand business classification to enable straight through processing of new business applications. Accurate and consistent classification is hindered by a number of factors including by not limited to: a limit to the number of classifications, e.g., there are many types of businesses but there are only a limited number of codes, resulting in one single code being used across multiple business types; there is cross-referencing within the classification codes, wherein the same business could be classified in more than one classification code and the classification codes could be tied to different insurance rates; business owner's who initially select applicable codes for their business don't actually understand the class codes; there is no single source of truth for classification codes, i.e., different class codes may be entered for same business when filling out SBA registration, IRS submission, Census—there is only about 60% agreement for a business across 3^{rd} party sources; businesses evolve over time which could change applicable classification; and limitations on existing classification models.

Further, in the current technological and big data environment, enterprises are turning to the development and production of machine learning models to support their businesses. FIG. 1 schematically represents the major operations which are employed to develop and implement machine learning models. Generally referred to in the art as MLOps, the five primary stages include: identification of business objective (Stage 1), data acquisition (Stage 2), model building and training (Stage 3), operationalization, i.e., model deployment, also called production (Stage 4) and model governance (Stage 5). But there is a substantial delay between training a working model, i.e., the data scientist gets it to work on their machine, and deploying the model for use by others, e.g., customers, in a production environment. Further, without a centralized system and template framework for deployment, different teams within an enterprise could deploy models in different ways, which creates technical debt as deployment of multiple models requires different procedures, e.g., custom procedures, for individual model maintenance and governance. This is inefficient and costly for the enterprise to maintain/service model production issues for every different deployment scenario.

Accordingly, there is a need in the art for a model core development framework which provides standardization or a template for model deployment/production so that an enterprise can standardize deployment, debugging, testing of multiple models, model maintenance, model degradation monitoring, etc., behind an endpoint. While platforms like AzureMLOps, Amazon and Google provide out-of-the-box model development platforms, there is no standardized/template core for deployment and related monitoring services.

### SUMMARY OF THE EMBODIMENTS

A first embodiment is directed to a processor-driven prediction engine for predicting a classification for an entity within a predetermined classification taxonomy. The processor-driven prediction engine includes: an ensemble of machine learning models including at least a gateway model, a concepts model and at least one classification model, wherein the gateway model predicts a first-level classification for the entity and the at least one classification model predicts a second-level classification for the entity.

A second embodiment is directed to a process for predicting a classification for an entity within a predetermined classification taxonomy. The process includes: predicting, by a processor-driven prediction engine, a first-level classification for the entity within the predetermined classification taxonomy; generating a concepts matrix including concept entries relevant to the classification of entities within the predetermined classification taxonomy; predicting, by the processor-driven prediction engine, a second-level classification for the entity within the predetermined classification taxonomy, wherein the prediction of the second-level classification utilizes the concepts matrix.

### BRIEF DESCRIPTION OF THE FIGURES

Example embodiments will become more fully understood from the detailed description given herein below and the accompanying drawings.

FIG. 1 is a prior art schematic showing the art-recognized stages of a machine learning operations process;

FIG. 2 is a schematic of a prediction engine in accordance with an embodiment described herein;

FIGS. 3a, 3b and 3c are exemplary extracted concepts which pertain to particular subsectors of the NAICS at the Group Code 3-digit level and are used to populate concept matrices for use in classification by the prediction engine of FIG. 2;

FIGS. 4a, 4b and 4c are exemplary extracted concepts which pertain to particular subsectors of the NAICS at the Class Code 6-digit level and are used to populate concept matrices for use in classification by the prediction engine of FIG. 2;

FIG. 5 is an exemplary matrix showing outcome accuracy of the model after NB and logistic regression in accordance with an embodiment herein;

FIGS. 6a and 6b are graphs showing class code distribution in the model training set (FIG. 6a) used to train the model of FIG. 5 and the resulting class code distribution (FIG. 6b) after NB and logistic regression accordance with an embodiment herein;

FIG. 7 shows an exemplary output matrix from a trained BLSTM model in accordance with an embodiment herein;

FIGS. 8a and 8b show exemplary prior art output classification matrices for best known BN and logistical model; and

FIG. 9 shows model core deployment framework architecture in accordance with an embodiment herein.

### DETAILED DESCRIPTION

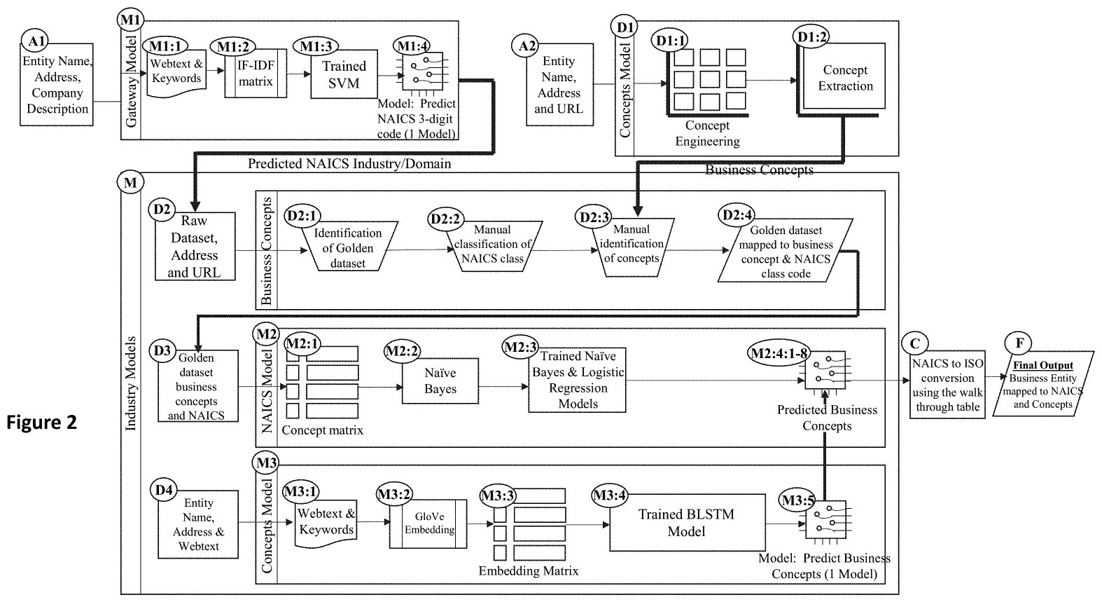

Referring to FIG. 2, in a first embodiment, an artificial intelligence (AI) prediction engine 10 is used to correctly classify a business based on US industry code, i.e., the NAICS. At a high level, the engine and process for using takes as inputs a business's social presence (e.g., name, web address, etc.) and address. The AI prediction engine 10 employs various machine learning models to solve a particular classification problem. Specifically, the AI prediction engine 10 is intended to address the NAICS code problem which seeks to classify businesses in particular industries in accordance with a numerical code, e.g., 2 to 6 digit code, for the purposes of generating insurance policies. It is well known to those skilled in the relevant art that, prior to giving/generating a business owner's insurance policy, insurance companies would like to know under which US Industry code the applying business belongs. A significant challenge in this area is determining correct classification; particularly for small businesses. Since the classification is not that accurate in the current environment, there is a problem of overpricing and underpricing policies, as well as long processing times. Accordingly, insurance companies are in need of a straightforward process for coding under the NAICS to inform policy. One skilled in the art will appreciate that the prediction engine described herein is not limited to application to NAICS classification, but could be trained and employed to classify businesses in accordance with other standards, e.g., ISO, SIC. And further that the

In the preferred embodiment, the AI prediction engine of FIG. 2 is built using a combination of 10 models and is capable of classifying a business into a single NAICS 6-digit classification with a high percentage of accuracy given simple input information consisting of, for example, a business's name, physical address and company description (A1). M1 is an initial filtering process which uses a gateway model which picks up text and uses simplistic thinking such as keyword repetition and distribution M1:1, builds a term frequency-inverse document frequency (TD-IDF) matrix M1:2 and divides in accordance with a trained support vector machine (SVM) M1:3 to establish a pattern which is used to predict industry to the 3rd digit M1:4 of the 6 digit NAICS code, i.e., this is a prediction of the sector and subsector of the NAICS. By way of example only, the following is an excerpt from Part I of the most recent version of the NAICS which shows exemplary 2-digit (Sector) and 3-digit codes (Subsector).
Sector 56. Administrative and Support and Waste Management and Remediation Services
   Subsector 561. Administrative and Support Services
   Subsector 562. Waste Management and Remediation Services
Sector 61. Educational Services
   Subsector 611. Educational Services
Sector 62. Health Care and Social Assistance
   Subsector 621. Ambulatory Health Care Services
   Subsector 622. Hospitals
   Subsector 623. Nursing and Residential Care Facilities
   Subsector 624. Social Assistance
Sector 71. Arts, Entertainment, and Recreation
   Subsector 711. Performing Arts, Spectator Sports, and Related Industries
   Subsector 712. Museums, Historical Sites, and Similar Institutions
   Subsector 713. Amusement, Gambling, and Recreation Industries
Sector 72. Accommodation and Food Services
   Subsector 721. Accommodation
   Subsector 722. Food Services and Drinking Places

This subsector level of industry (also referred to as domain-level) prediction is a gateway prediction which informs which load to pick up further in the prediction engine process at the NAICS model M2. Accordingly, the gateway model M1 should be able to classify most businesses accurately to subsector, i.e., 3-digit NAICS code, using high level, public information.

In order to build and train the prediction engine to predict the NAICS code to the 4^{th}, 5^{th} and 6^{th} digits, the process utilized three primary data sets: training data, validation/test data, and a golden data set or absolute data set. The training and validation/test data sets were taken from a larger data pool of individual data sets generated by scanning numerous existing (e.g., third-party) sources, with millions of existing business-assigned NAICS records, wherein business (entity) names, descriptions, addresses (web and physical) with assigned NAICS codes represented individual data sets. The model was continuously trained on the training data and it was continuously validated on the test data; the data set distribution being approximately 70% (training data) and 30% (validation data). The golden data set was a set of 300 hand-curated, 100% accurate data sets that the models have never seen over the entire life cycle of initial training and validation.

But the initial individual data sets from the larger data pool had two problems. First, the data was very, very noisy in due to human error, due to use of basic (and often inaccurate) models by syndicated data providers and due to ambiguity in NAICS class code definition. Accordingly, outcome accuracy using just the initial individual data sets was only about 45-50%. A deployment-level machine-learning (ML) model cannot be built if training data has high noise level. This is one of the biggest challenges with building a useable model/prediction engine. The second problem is what is known in the art as a signaling problem. That is, when we tried to take a signal, i.e., parameters/features unique to classes, out of the training data sets, we were at less than 10% accuracy of the outcome accuracy of 50%. So the initial two data problems were (1) noisy and (2) data had no signals.

To address the data noise issue, the data sets from the initial individual data sets from the larger data pool were first run through a framework based on the Snorkel process described in the paper entitled “Snorkel: rapid training data creation with weak supervision” published online: 15 Jul. 2019 (The VLDB Journal (2020) 29:709-730), which is incorporated herein by reference in its entirety. Snorkel builds a weak supervision model using snorkel—domain heuristic label functions i.e. weak supervision models. Next, training data is augmented with class keywords and class description. To address the signaling issue with the initial individual data sets from the larger data pool, the present embodiments incorporate a natural probability model, concept engineering and naïve bayes probability processes as discussed further herein.

Concepts engineering is rooted in the requirement for pattern identification for classification. For the particular use case described in the present embodiment, patterns may be established by first describing a business by using their own features. Accordingly, a concepts model or feature matrix was developed in D1 using input A2 which can clearly identify a particular business (e.g., entity name, address and URL). At a high level, features were defined and then extracted from a classification standpoint and concepts were derived from classification descriptions available for the particular industry.

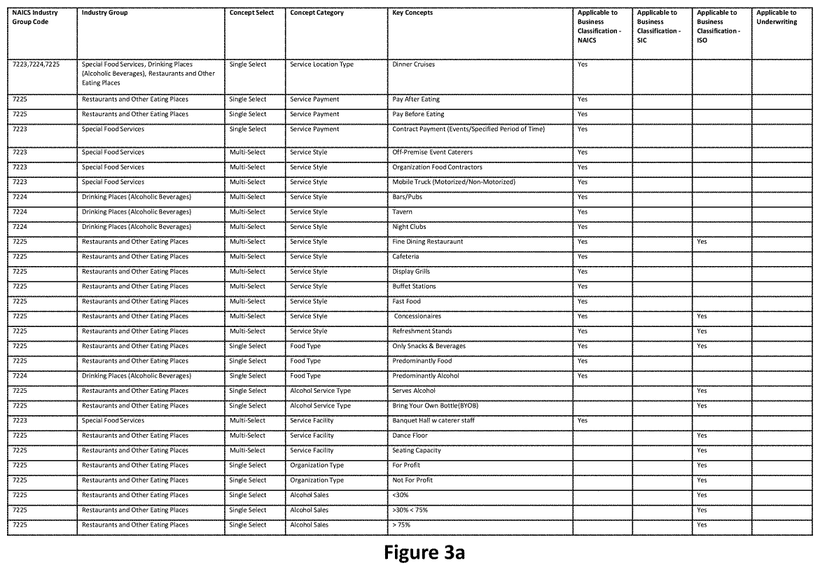

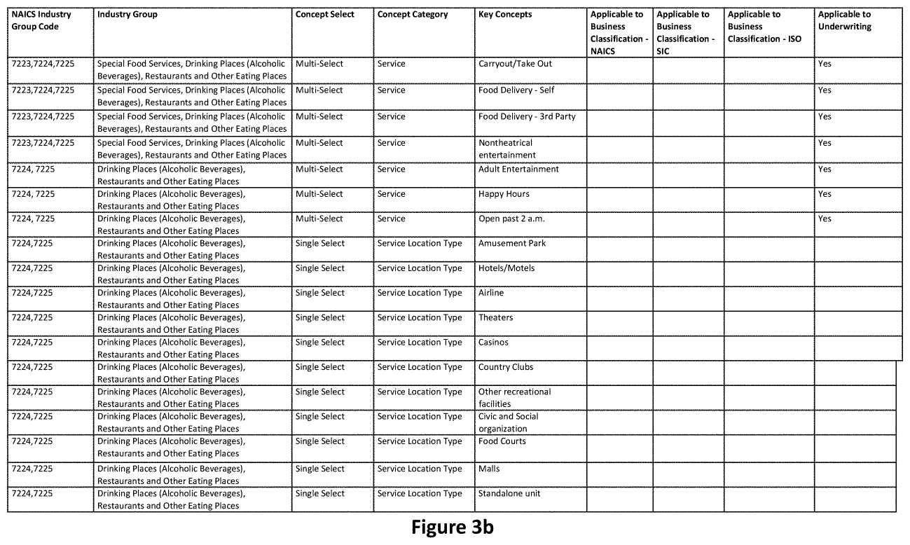

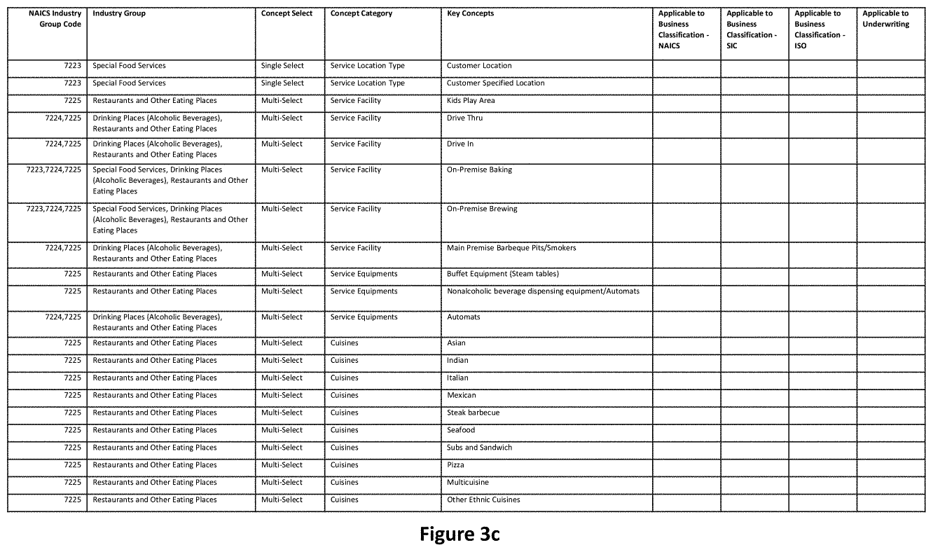

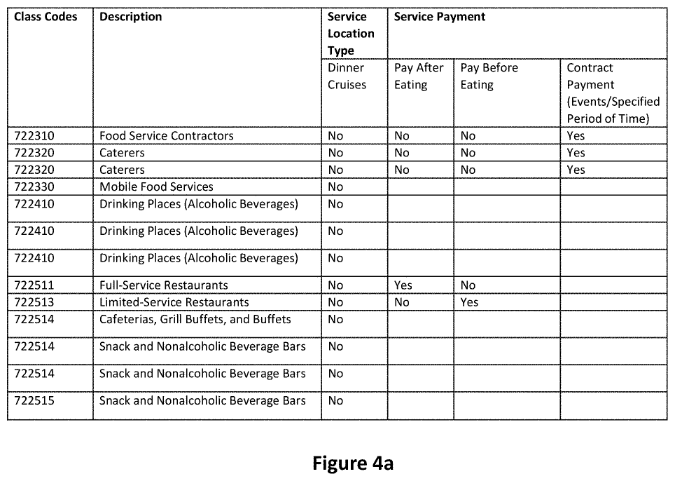

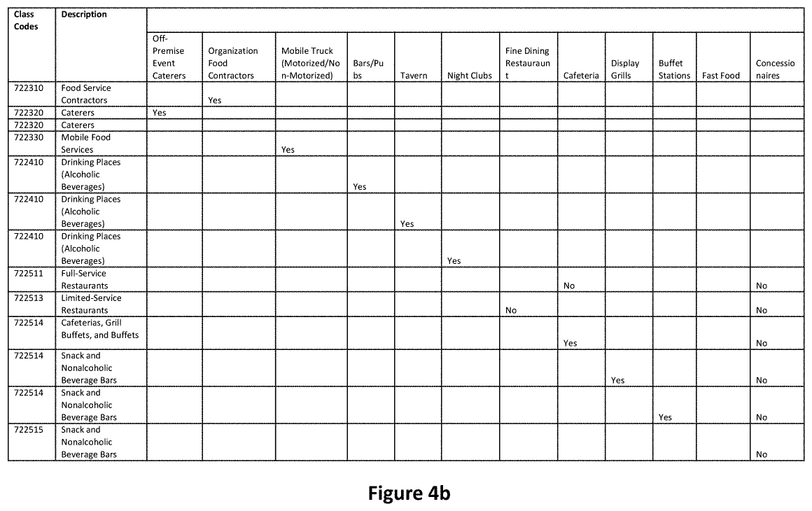

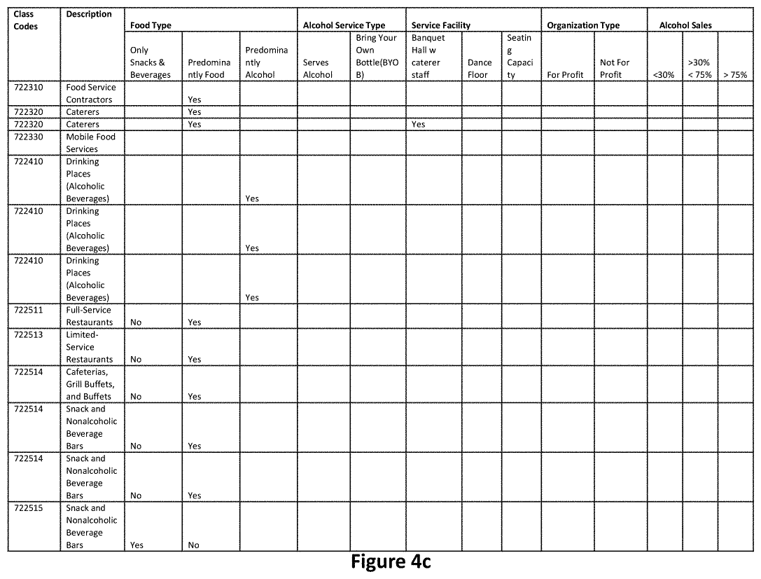

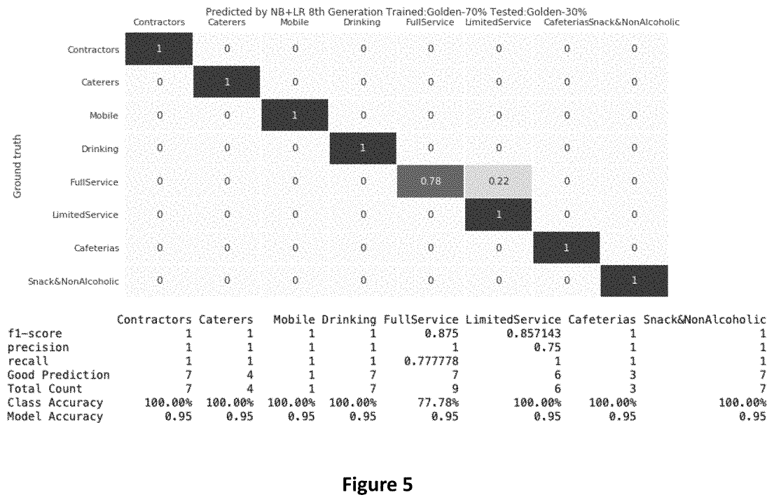

For example, within the NAICS classification code, at the 4-digit classification level in the NAICS (Group Code level), there are several concepts that can be extracted to help train the model and improve accuracy. By way of specific and non-limiting example, see FIGS. 3a, 3b, 3c, which provide additional extracted concepts which pertain to the subsector 722: Food Services and Drinking Places and Group Codes 7223, 7224 and 7225. At this level of classification, it was observed that classification does not change with certain features, i.e., certain features are found in two or three of the Group Codes (7223, 7224, 7225), whereas other feature are unique to a single Group Code. Similarly, additional features can be manually extracted at other classification levels. FIGS. 4a, 4b, 4c provide additional extracted concepts which pertain to the subsector 722: Food Services and Drinking Places and Group Codes 7223, 7224 and 7225, at the Class Code, 6-digit classification level. Additionally, other concepts and features within the domain can be identified and coded to improve model training. For example, in the present embodiment, training was improved by manual coding to map service type, e.g., full service, limited service, caterers, mobile, etc. with identified features relevant to service type (see, e.g., FIG. 5).

Additionally, absolute truths/falsehoods for classification in certain class can also be coded into the model training. For example, if it is determined that, e.g., Concept A must be true if a business is to be classified as a food service contractor and Concept B must be false for a business to be classified as food service contractor, these requirements can be coded into the model. All of the above-described manual extraction of business concept/feature description can be converted into language, e.g., concept matrix including matrix rules, that the training system can understand.

At this point in the model build, with the prediction engine, trained with cleaned data sets and the concepts matrix alone resulted in approximately 50% classification accuracy. This is because even with manual concept and feature extraction, it is not possible to know all of the concepts and there are overlaps, so even with matrix rules, there are ambiguities.

Accordingly, as a next step in the build, the resulting rules-based concepts model is converted to a concept delivery matrix D1:2 which is a simple mathematical conversion and the matrix is married with the manually curated golden data set at D2:3. The manually curated golden data sets can be exactly matched to the concepts/features for a particular classification using the concept delivery matrix D1:2. The model can clearly identify in its own language that a particular class code means this particular segment and this is how it's pattern looks. Testing the prediction engine trained using cleaned data sets D2, with the concept matrix rules married to the golden data set, resulted in a classification accuracy of approximately 70-75% (D2:4).

Next, the naïve Bayes (NB) concept is applied to the golden dataset training concept matrix in M2, which is to say this it converts the particular incoming training concept matrix M2:1 into some different level of matrix, i.e., NB matrix M2:2, using probabilistic thinking. Use of NB in the machine-learning art is known and described in, for example, “Naive Bayes for Machine Learning” (Apr. 11, 2016 in Machine Learning Algorithms) and Kaggle Notebook “NB-SVM strong linear baseline” both of which are found in the provisional patent application to which this case claims priority and which are incorporated herein by reference in their entirety.

The NB matrix output is then put through a simple logistic regression in M2:3. Simple logistic regression is described in, for example, “Logistic Regression for Machine Learning” (Mar. 31, 2016 in Machine Learning Algorithms). Testing the model trained using cleaned data sets, with the concept matrix rules married to the golden data, converted to NB matrix and run through linear regression resulted in a classification accuracy of the prediction engine of 90%.

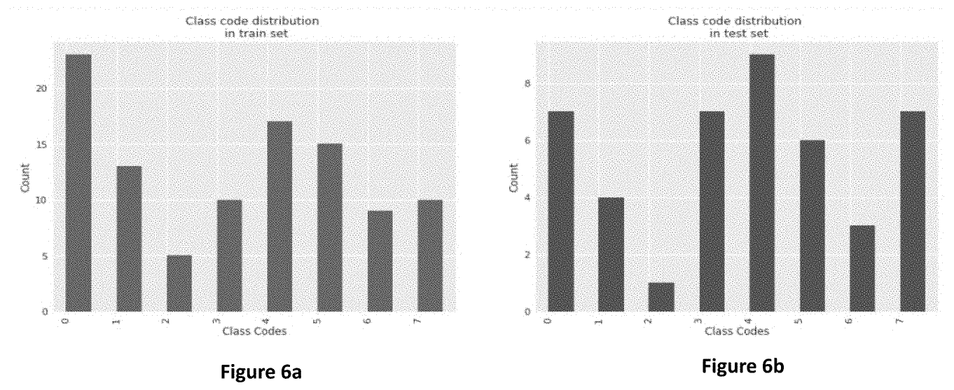

The matrix in FIG. 5 and bar graphs at FIGS. 6a and 6b show exemplary outcome accuracy of the model after NB and logistic regression is close to 95%. There were some challenges in this particular model with “full service” classification because in the curated golden dataset, some restaurants do both, which presents a major challenge/ambiguity.

Accordingly, at this point in the prediction engine model build, there is a mechanism by which the model/prediction engine can understand a NAICS classification code and if we run through the process to this point, will get above 90% classification accuracy.

But to this point, the concepts extraction process described above was performed manually from a URL/website (e.g., 123biz.com) in D1 and the Golden data set was built manually. In this process, URL, e.g., 123biz.com, can be used by a web crawler that goes and finds out all “social” data and converts the data into a blob of text. Blob of text needs to be read manually and converted into extraction concepts and then it can run through the lifecycle through to M2.3. To automate this reading and conversion into extraction concepts, at M3, the blob of text M3:1, e.g., web text and keywords, are converted into GloVe embedding M3:2 (i.e., cosine distance between two different English words) and provided in an embedding matrix M3:3. In a specific example, 300 dimensional vectors were used for the embedding (but this could be different number). When running with the 300 dimensional vectors embedding, the automatic concepts extraction from the blob of text had approximately 65%-70% accuracy. The embedding matrix is converted to a format that can be used by M2:4:1-8 via a trained BLSTM model M3.4. An exemplary BLSTM model is described in “Long Short-Term Memory Based Recurrent Neural Network Architectures for Large Vocabulary Speech Recognition,” (arXiv:1402.1128v1 [cs.NE] 5 Feb. 2014), which is incorporated herein by reference in its entirety.

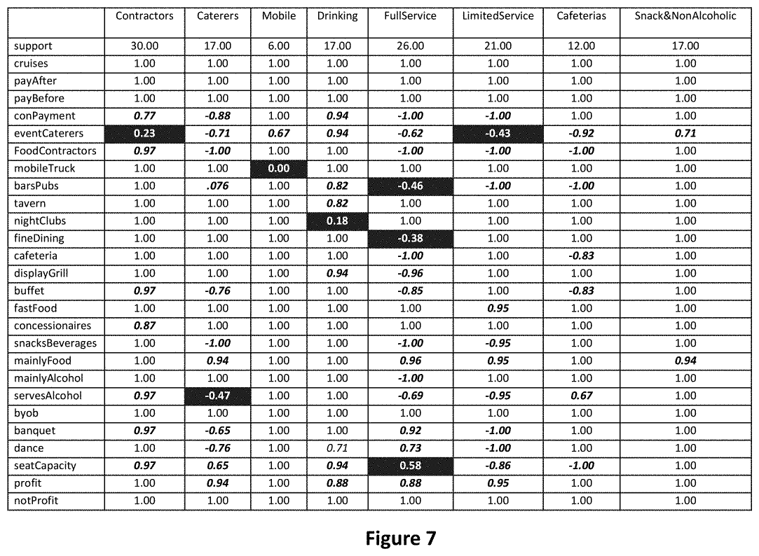

FIG. 7 shows an exemplary output matrix from a trained BLSTM model M3.4 wherein the automated reading and conversion of D4 into extraction concepts was implemented. Cells of the matrix with entries/cells showing 1.00 are indicative of 100% accuracy, bold and italicized entries/cells are able to classify at less than 100% accuracy and black cells (8 shown) are unable to classify.

The M3:5 output of this automatic concept extraction is presented to M2:4.1-8 models to predict the final NAICS classification. The M2:4.1-8 models are 8 different models, each having a different task in the NAICS prediction process. And in practicality, there are 16+1+1 models running since there are technically 8 NB models which overlay on 8 logistic regression models. These 8+8 models receive the same data, i.e., same input message for all models and output different probabilities based on internal weights. All outputs are assembled into a single probabilistic output. The prediction engine takes the highest probability as the predicted class NAICS class. In step C, walk through tables may be used to convert classifications from, say NAICS to ISO.

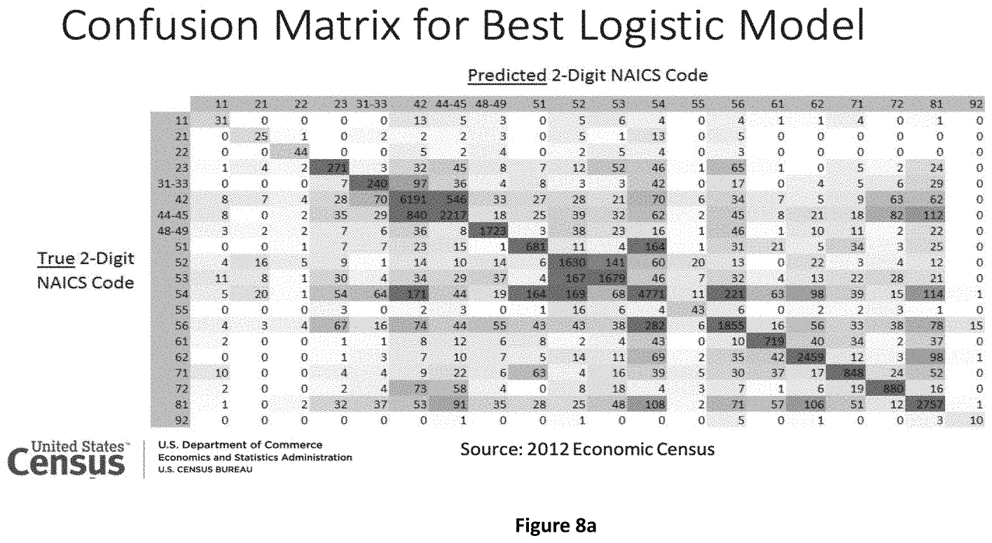

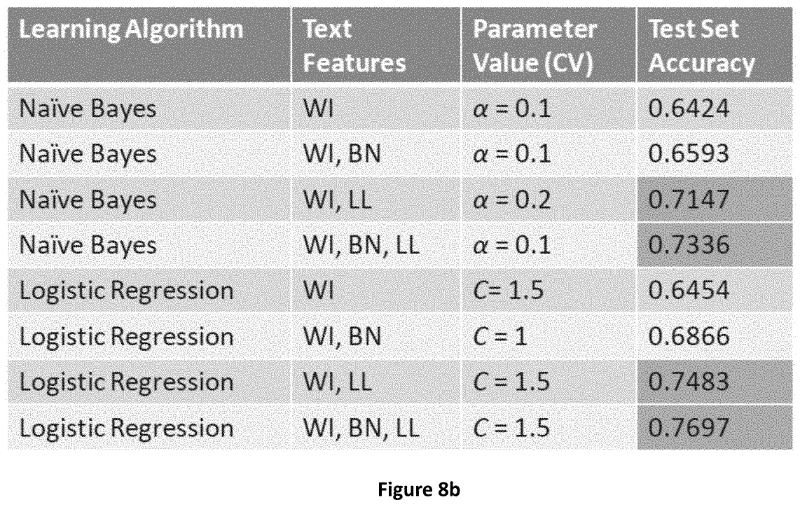

By way of example, and for comparison, FIG. 8a shows the confusion matrix for the current prior art best learning model used for prediction which is only to 2-digits in the NAICS code. The example describes attempts to classify businesses to the 2-digit, Sector level, of the NAICS using types of descriptive data collected from the 2012 economic census. The different types of data, i.e., text features, used in the predictions included Write-In data (WI) which was self-designated type of business provided by businesses responsive to the census; Business Name (BN) and Line label (LL) which was a checkbox description associated with the WI text box. Using different combinations of these features in both an NB and logistic regression type of algorithm, the highest accuracy of 2-digit NAICS accuracy achieved was with LR at 77% as shown in FIG. 8b. Additional details behind this prior art study are discussed in the presentation available at the United States Census Bureau and on-line in the presentation by Dumbacher and Russell at the Jul. 29, 2019 Joint Statistical Meeting entitled Using Machine Learning to Assign North American Industry Classification System Codes to Establishments Based on Business Description Write-Ins, which is incorporated herein by reference in its entirety. Whereas the prediction engine built and trained in the preferred embodiment herein is able to improve upon the prior art model and classify a business to the 6-digit NAICS code with a high degree of accuracy.

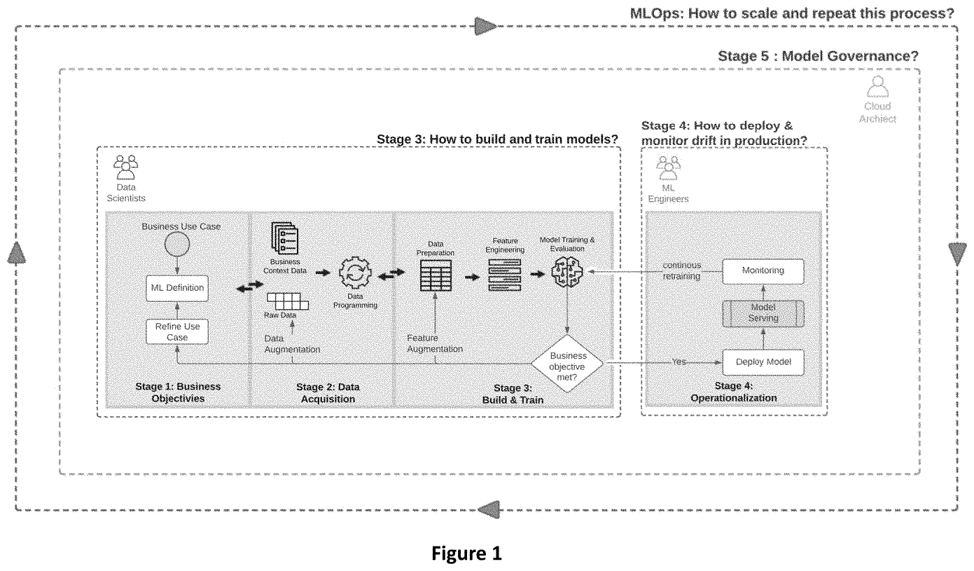

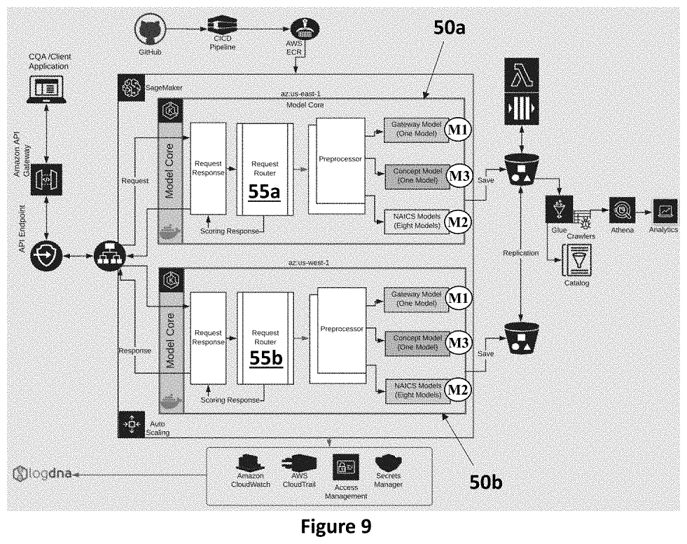

In a further embodiment, a model operationalization framework is described which significantly reduces the time it takes an enterprise to take a trained model(s), such as those described in the first embodiment herein, and deploy, i.e., productionize the model(s). This embodiment results in significant improvements in Stage 4 of the MLOps process of FIG. 1. At the heart of the model operationalization framework is a model core having an architecture exemplified in FIG. 9. The model core architecture facilitates the ability of an enterprise to configure how the enterprise deploys their models. It facilitates standardization of an enterprise's model deployment. Enterprises face a myriad of model issues as deployed models age and new models are developed and trained. Without standardization and support across the enterprise for model deployment, the siloed nature of individual model deployment, debugging, etc. is costly and inefficient. If an enterprise allows every team to develop and implement their own way of deploying models, the expense to the enterprise may outweigh the benefits to the enterprise.

In FIG. 9, for each Model Core 50a, 50b, Request Routers 55a, 55b can be configured to route requests to the different models in accordance with different parameters or filters, such as: probabilistic distribution, e.g., % that should go to model A is 90% versus model B 10%; or can route to different models based on geography, e.g., where requests originate (Japan vs. US); or can route based on other requirement(s) like domain heuristics, e.g., life insurance vs. restaurant classification vs. car insurance or combinations thereof. The Request Routers 55a, 55b are configurable out of the box. One skilled in the art will recognize that the components outside of the Model Cores 50a, 50b, are known in the art and in FIG. 9 are supported by the Amazon's AWS suite of support products. Other product suites may be used.

The model core deployment framework architecture is capable of performing regular “checks” on the model deployment. The checks help to address an emerging area in the ML community referred to as model degradation. The model core deployment framework architecture monitors the ML model, which, in the specific embodiment herein is continuously predicting a class code, for signs of breakdown in the model performance. Breakdowns, also called drifts, happen, for example, when a model is based on single data points, like the prediction engine of the first embodiment which uses website and physical address to initiate the classification process. These single data points are used to facilitate data collection through web crawling, and this data is used in the concepts model and matrix. But this data may change. For example, with COVID, restaurant features changed, i.e., the web text for previously classified full service restaurants, suddenly looks more like the business is a limited service restaurant, so the web site data that was crawled originally has changed and the model may struggle to find a class that fits. This can be thought of as concept drift, which is a form of model degradation. The model core deployment framework architecture of FIG. 9 is able to monitor and correct for this concept drift scenario.

Another example of model degradation can be seen in a second example. Say an ML model takes square footage across all restaurants across all of the United States, and there is a pattern that emerges across class codes that is tied to the square footage column in the feature matrix. In the future, the square footage column could change such that it no longer falls into the previously determined pattern and confuses the classification. Using concept of Wasserstein distance, i.e., the distance between two distributions, if there is wide separation, then you can say your model data is drifting. This is data drift, which also degrades the model. The model core deployment framework architecture of FIG. 9 is able to monitor and correct for this data drift scenario.

Additionally, the model core deployment framework architecture supports AB Testing, i.e., given model A and model B, which is performing better, i.e., which segment of the population/customer base is able to convert based on which model. This sort of classification between models is an especially important feature.

Further, the model core deployment framework architecture supports semantic logging. When you write a log, you want to trace a particular decision that you have made. What the core does is writes some trace codes into the standard input/output using, e.g., Cloudwatch, Log DNA. In prior art systems, if you write a simple line like “received request” or “weight is 54 lbs” (when requirement is more than 100 lbs) and you log like this, it is difficult to support this type of logging from a production environment because when you have a production problem you have to resolve that problem within a particular SLA and most of the time these SLAs are say 4-8 hours based on severity problem. The present embodiment supports semantic logging. Since prior art logging tools like log DNA do understand semantics, the model core uses semantic logging mechanisms in order to show the user on their dashboard, in real-time, exactly what is happening. This significantly reduces the resolution of a production problem since the system can be monitored in real-time using semantic logging.

The model core deployment framework architecture supports a novel use of the persistence layer which allows hooks. The model core deployment framework architecture uses the persistence layer which is available with prior art ML packages, e.g., Azure MLOps Amazon, Google, etc., to persist the request that has come into the model core for decision-making and it persists the change the model has made responsive to the request. So, a request to: “classify ABCbiz.com” is persisted and the model's response to the request, i.e., NAICS classification, is also persisted. This persistence supports auditing, traceability and compliance requirements.

Data scientists team are always worried: is the model I trained the same model that is running in production? In order to do something like that you need a mechanism by which you can fingerprint your own models and then make sure that is the same model that is going to production. The inherent capability of this framework is that it will not take a model that is not fingerprinted. When the models is presented for deployment, the model provider must give model artifacts and artifact signatures (hashed values). The present framework has a place where you put the signature and has a place where you put the model itself and at runtime, before loading the model for operations or serving, it is going to validate whether the model and the provided signature match before serving.

In a related example, for request/response validation, if a request is coming, there needs to be a mechanism to validate the request. So, say today you have restaurant data which is crawled off of web and returned, plus you have concept matrix provided to the model, in the request for decision making by the model. But then tomorrow you want to add one more component to the request, such as, demographics data, to the request. The present framework negates the prior art requirement that an additional validation layer needs to be written for the demographics layer. Instead, the present framework's request/response validation has a mechanism whereby you can go to the original request and add a small section or component to it and provide the validation segment for that particular added section or component, with the need to write an entirely new validation layer.

It is submitted that one skilled in the art would understand the various computing environments, including computer readable mediums, which may be used to implement the systems and methods described herein. Selection of computing environment and individual components may be determined in accordance with memory requirements, processing requirements, security requirements and the like. It is submitted that one or more steps or combinations of step of the methods described herein may be developed locally or remotely, i.e., on a remote physical computer or virtual machine (VM). Virtual machines may be hosted on cloud-based IaaS platforms such as Amazon Web Services (AWS) and Google Cloud Platform (GCP), which are configurable in accordance with memory, processing, and data storage requirements. One skilled in the art further recognizes that physical and/or virtual machines may be servers, either stand-alone or distributed. Distributed environments many include coordination software such as Spark, Hadoop, and the like. For additional description of exemplary programming languages, development software and platforms and computing environments which may be considered to implemented one or more of the features, components and methods described herein, the following articles are reference and incorporated herein by reference in their entirety: Python vs R for Artificial Intelligence, Machine Learning, and Data Science; Production vs Development Artificial Intelligence and Machine Learning; Advanced Analytics Packages, Frameworks, and Platforms by Scenario or Task by Alex Castrounis of InnoArchiTech, published online by O'Reilly Media, Copyright InnoArchiTech LLC 2020.

The foregoing description is a specific embodiment of the present disclosure. It should be appreciated that this embodiment is described for purpose of illustration only, and that those skilled in the art may practice numerous alterations and modifications without departing from the spirit and scope of the invention. It is intended that all such modifications and alterations be included insofar as they come within the scope of the invention as claimed or the equivalents thereof.

We claim:

1. A processor-driven prediction engine for predicting a classification for an entity within a predetermined classification taxonomy, comprising:
an ensemble of machine learning models including at least a gateway model, a concepts model and at least one classification model, wherein the gateway model predicts a first-level classification for the entity and the at least one classification model predicts a second-level classification for the entity.

2. The processor-drive prediction engine of claim 1, wherein first data input to the gateway model includes at least one of the following selected from the group consisting of: entity name, entity address and entity description.

3. The processor-driven prediction engine of claim 1, wherein the concepts model is selected from the group consisting of: a manually generated matrix of concepts relevant to the classification of entities within the predetermined classification taxonomy and a processor-generated matrix of concepts relevant to the classification of entities within the predetermined classification taxonomy.

4. The processor-driven prediction engine of claim 1, wherein the at least one classification model includes at least one Naïve Bayes model and at least one logistic regression model for use in predicting the second-level classification for the entity.

5. The processor-driven prediction engine of claim 4, wherein the at least one classification model includes eight Naïve Bayes models and eight logistic regression models for use in predicting the second-level classification for the entity.

6. The processor-driven prediction engine of claim 3, wherein the processor-generated concepts matrix is generated using at least a BLSTM model.

7. The processor-driven prediction engine of claim 6, wherein second data input to the processor for generating the concepts matrix includes at least one of the following selected from the group consisting of: entity name, entity address and entity URL and entity-related web text.

8. The processor-driven prediction engine of claim 1, wherein the gateway model is a SVM trained to predict the first-level classification.

9. The processor-driven prediction engine of claim 1, wherein the predetermined classification taxonomy is the North American Industry Classification System (NAICS) code.

10. The processor-driven prediction engine of claim 9, wherein the first-level classification is to a first 3-digits of the NAICS code and the second-level classification is to 6-digits of the NAICS code.

11. A process for predicting a classification for an entity within a predetermined classification taxonomy, comprising:
predicting, by a processor-driven prediction engine, a first-level classification for the entity within the predetermined classification taxonomy;
generating a concepts matrix including concept entries relevant to the classification of entities within the predetermined classification taxonomy;
predicting, by the processor-driven prediction engine, a second-level classification for the entity within the predetermined classification taxonomy, wherein the prediction of the second-level classification utilizes the concepts matrix.

12. The process for predicting a classification for an entity within a predetermined classification taxonomy of claim 11, further comprising:
predicting the first-level classification using an SVM trained gateway model.

13. The process for predicting a classification for an entity within a predetermined classification taxonomy of claim 11, further comprising:
generating the concepts matrix using at least a BLSTM model.

14. The process for predicting a classification for an entity within a predetermined classification taxonomy of claim 11, further comprising:
predicting the second-level classification with at least one Naïve Bayes model and at least one logistic regression model.

15. The process for predicting a classification for an entity within a predetermined classification taxonomy of claim 14, further comprising:
predicting the second-level classification with eight Naïve Bayes models and eight logistic regression models.

16. The process for predicting a classification for an entity within a predetermined classification taxonomy of claim 12, further comprising:
receiving first data at the processor-driven prediction engine including at least one of the following selected from the group consisting of: entity name, entity address and entity description, wherein the first data is used by the SVM trained gateway model to determine the entity's first-level classification.

17. The process for predicting a classification for an entity within a predetermined classification taxonomy of claim 11, further comprising:
receiving second data at the processor-driven prediction engine including at least one of the following selected from the group consisting of: entity name, entity address and entity URL and entity-related web text, wherein the second data is used to generate the concepts matrix.
